(19) United States
(12) Patent Application Publication
(10) Pub. No.: US 2022/0410262 A1
(43) Pub. Date: Dec. 29, 2022

(54) ADDITIVE MANUFACTURING OF GAS TURBINE COMPONENTS USING CARBON NANOSTRUCTURES

(71) Applicant: SIEMENS ENERGY GLOBAL GMBH & CO. KG, München (DE)

(72) Inventors: Kai Kadau, Lake Wylie, SC (US); Michael Clossen-von Lanken Schulz, Issum (DE)

(21) Appl. No.: 17/898,546

(22) Filed: Aug. 30, 2022

Related U.S. Application Data
(63) Continuation-in-part of application No. 16/755,610, filed on Apr. 13, 2020.

(51) Int. Cl. B22F 5/04; B33Y 80/00; B33Y 70/10; B33Y 10/00; B22F 10/28; B22F 12/45; B22F 9/04

(52) U.S. Cl. CPC B22F 5/04; B33Y 80/00; B33Y 70/10; B33Y 10/00; B22F 10/28; B22F 12/45; B22F 9/04; B22F 2302/403

(57) ABSTRACT

A component for a gas turbine engine can be made via additive manufacturing. During the additive manufacturing process a powder can be used that comprises a superalloy material (12) and carbon nanostructures (14a, 14b). Components made using the powder can have preferred characteristics at certain locations through the use of the carbon nanostructure based additive manufacturing powder.

### BACKGROUND

### 1. Field

Disclosed embodiments are generally related to additive manufacturing and in particular to the materials used in additive manufacturing.

### 2. Description of the Related Art

Additive manufacturing can be used to make various components. Casting a part from a fluidized bed of a powdered metal is disclosed in U.S. Pat. No. 4,818,562 (the '562 Patent), the content of which is fully incorporated herein by reference. The '562 Patent generally discloses the introduction of a gas into a bed of powdered metal and selectively heating regions of the powdered metal using a laser. In particular, the '562 Patent discloses the introduction of an inert gas such as argon, helium, and neon. The inert gas is provided to displace any atmospheric gases that may react with the hot or molten metal to form metal oxides, which may compromise the integrity of a component. The '562 Patent also discloses that gas used to fluidize the powder may be a reactive gas such as methane or nitrogen; however, without introduction of the inert or other shielding mechanism, the risk of that the constituents of the molten metal will react with available elements remains.

While additive manufacturing has been used to create many types of components there is a continued need to create components of having superior qualities.

### SUMMARY

Briefly described, aspects of the present disclosure relate to a component and method for making a component using carbon nanostructures in additive manufacturing.

An aspect of the present disclosure may be gas turbine component made via additive manufacturing. The component may be made of a superalloy material and carbon nanostructures, wherein the carbon nanostructures are interspersed throughout the gas turbine component via additive manufacturing.

Another aspect of the present disclosure may be a method of making a component. The method may comprise using an additive manufacturing powder in an additive manufacturing apparatus in order to form the gas turbine component via additive manufacturing, wherein the additive manufacturing powder is a composition comprising a superalloy material and carbon nanostructures.

Still yet another aspect of the present invention may be a method of making a composite particle. The method may comprise casting a slab comprising superalloy material and at least one carbon nanostructure; and milling the slab to form the composite particle comprising the superalloy material and the at least one carbon nanostructure, wherein the composite particle is for an additive manufacturing process.

### BRIEF DESCRIPTION OF THE DRAWINGS

FIG. 1 is a schematic illustrating an additive manufacturing powder formed from both superalloy materials and carbon nanostructures.

FIG. 2 shows a composite particle used in an additive manufacturing process that is formed from superalloy material and a carbon nanostructure.

FIG. 3 is a schematic illustrating an additive manufacturing powder formed from both superalloy materials and composite particles.

FIG. 4 is a schematic of an additive manufacturing bed used in forming a component using superalloy particles and carbon nanostructures.

FIG. 5 is a gas turbine engine component constructed using superalloy material and carbon nanostructures illustrating where high concentrations of nanostructures are located.

FIG. 6 is an illustrative view of a gas turbine engine component formed from superalloy material and carbon nanostructures showing the concentration of nanostructures.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art.

The various embodiments are intended to be illustrative and not restrictive. Many suitable mixtures that would perform the same or a similar function as the additive manufacturing powders described herein are intended to be embraced within the scope of embodiments of the present disclosure.

The present inventors have discovered an enhanced additive manufacturing process that can be used with superalloy materials. Possible superalloy materials that can be employed may be nickel based superalloy material or cobalt based superalloy material. Superalloys typically have a face centered cubic crystal structure and can be utilized up to high temperatures due to specific microstructural properties that inhibit dislocation movement in the face-centered cubic matrix. Some commercial examples of superalloys include but are not limited to Hastelloy, Inconel (e.g., IN100, IN600, IN713, IN718, IN738), Waspaloy, Rene alloys (e.g., Rene 41, Rene 80, Rene 95, Rene N5), Haynes alloys, Incoloy, MP98T, TMS alloys, and CMSX. Besides superalloys other high-performance alloys such as Al—Li, Ti-alloys, as well as high temperature steels can benefit from the disclosed procedure.

The additive manufacturing processes described herein uses superalloy materials and carbon nanostructures to enhance material properties. This use of the superalloy material and the carbon nanostructures may be used for hot gas path parts such as blades and vanes in a gas turbine engine. The types of carbon nanostructures may be single- or multi-walled carbon nanotubes, nanobuds—where fullerene-like “buds” are covalently attached to the outer sidewalls of corresponding nanotubes, spherical fullerene (carbon nano-spheres, sometimes referred as Bucky balls), or graphene. Graphene is a one-atom layer thick layer of the mineral graphite with the carbon atoms arranged in a honeycomb lattice. Other types of carbon nanostructures may be carbon nanoyarn including but not limited to a highly-twisted double-helix carbon nanotube as described in CS Nano, 2013, 7(2), pp 1446-1453. Also, nanoyarn can be designed to variable length and thickness in order to promote specific stabilizing effects in the metallic matrix.

The carbon nanostructures stabilizes the microstructure of the additive manufacturing built part and may result in superior properties even for high operating temperatures. Carbon nanostructures such as carbon nanotubes, carbon nano-spheres (fullerene) and graphene can improve the performance of additive manufactured products. Due to the high melting point of carbon nanostructures, which can be up to 3000° C., carbon nanostructures can be used in additive manufacturing without being destroyed by a laser driven additive manufacturing process. It should be understood that while a laser driven additive manufacturing process (such as powder bed 3D printing, selective laser melting (SLM), selective laser sintering (SLS), direct metal laser sintering (DMLS) is discussed herein, other types of additive manufacturing processes may be used, such as electron beam melting (EBM) or electron beam freeform fabrication (EBF).

There are several reasons for the advanced mechanical properties for additive manufactured components that include carbon nanostructures. Grain boundary stabilization and cohesion between grain boundaries enhances the physical stability of the components. Those structures may have a positive stabilizing effect on the microstructure (for instance gamma-prime and gamma-prime-prime precipitates) which will result in preferred material properties even for high temperatures. This can reduce degradation due to aging. Deleterious processes are mostly dominated by dislocation activity in the matrix, which may be reduced by carbon nanostructures. Furthermore, fullerene carbon nanostructures can stabilize microstructures well with respect to dislocation mobility. Hence, material degradation and aging that affects important structural integrity aspects of a GT component such as creep, strength, and fatigue including thermomechanical fatigue (TMF), low cycle fatigue (LCF), as well as fatigue crack growth (FCG) can be controlled by adding those to the matrix. It should also be noted that different types of carbon nanostructures can have different stabilization processes. For instance, whereas a spherical fullerene can significantly reduce the dislocation mobility in the face-centered-cubic matrix, cylindrically shaped carbon nanotubes can also stabilize two adjacent microstructural boundaries such as gamma gamma-prime boundaries. Longer nanoyarn structures can stabilize gran-boundaries and precipitates. Hence, a combination of different types and sizes with specific concentration ranges are most beneficial. The exact combination depends on the superalloy, geometry of part, as well as service conditions.

Referring to the figures now, there are different ways in which the carbon nanostructures can be incorporated into the additive manufacturing process. The carbon nanostructures and the superalloy material may be selected from the examples provided above depending on the need and circumstances of the component being manufactured.

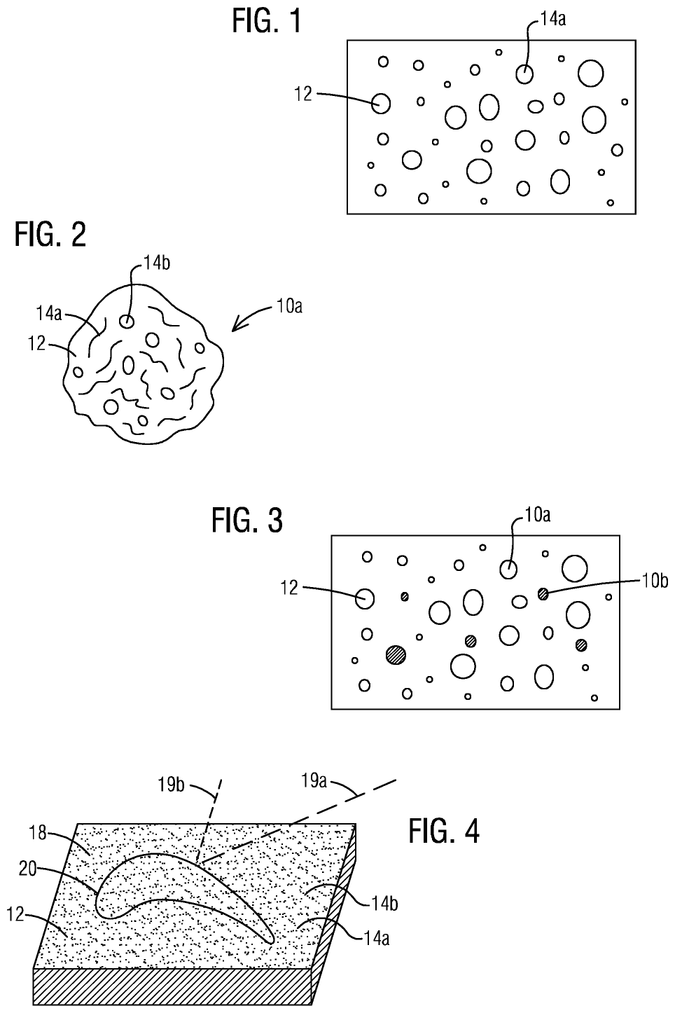

Referring to FIG. 1, one way in which to form components using superalloy material 12 and carbon nanostructures 14a is to mix the carbon nanostructures 14a into the additive manufacturing powder made of superalloy material 12. This results in a relatively homogeneous concentration of carbon nanostructures 14a in the powder formed from superalloy material 12. More than one type of carbon nanostructures 14a can be mixed with the powder of superalloy material 12. Likewise, more than one superalloy material 12 may be mixed with the carbon nanostructures 14a. It should be understood that FIG. 1 is for illustrative purposes and that the superalloy material 12 may be collection of milled particles formed from molecules of the superalloy material 12.

An additive manufacturing powder formed from a mixture of a powder of superalloy material 12 and a powder of carbon nanostructures 14a is easy to use in existing processes for additive manufacturing and could be employed in existing additive manufacturing machines. A potential drawback of using a powder of carbon nanostructures 14a and of the superalloy material 12 is that de-mixing of carbon nanostructures 14a and the powder of superalloy material 12 can occur.

In addition to having a powder of superalloy material 12 and carbon nanostructures 14a, a composite particle 10a that has both superalloy material 12 and carbon nanostructures 14a can be utilized. These particles can be produced by including the desired carbon nano-structure concentrations, sizes, and types during the casting process. The so-produced casted slabs can be milled to obtain the desired size distribution utilized as composite particle 10a. FIG. 2 shows a composite particle 10a that is made of a superalloy material 12, a first carbon nanostructure 14a (for instance carbon nanotubes), and a second carbon nanostructure type 14b (for instance a spherical fullerene). The composite particle 10a may already contain the carbon nanostructures 14a in the desired concentration. The desired concentration may change depending on the particular purpose of the component that is being constructed via the additive manufacturing process. By constructing a composite particle 10a that has both superalloy material 12 and carbon nanostructures 14a, the homogeneity of the composite particle 10a and the eventual composition of the component can be better controlled. The typical size of the composite particle 10a may be between 1-50 micrometers, depending on the layer height of the component that is being formed via the additive manufacturing process.

While the above example of a composite particle 10a discusses the use of one superalloy material 12 and one or two carbon nanostructure 14a and 14ab, more than one superalloy material and more than two kinds of carbon structures and sizes may be used to manufacture the composite particle 10a. Furthermore, it is contemplated that more than one composite particle 10a having different superalloy materials 12 and carbon nanostructures 14a, 14b may be used in the additive manufacturing process. This is shown below with respect to FIG. 3. Also, establishing gradients of concentration (both superalloy materials 12 and carbon nanostructures 14a, 14b) to support certain regions such as the surface of a component can be beneficial.

In FIG. 3, two composite particles 10a and 10b are used in the powder. The composite particles 10a, 10b may be made of different amounts of superalloy material 12 and carbon nanostructures 14a, 14b. Also shown in FIG. 3 are particles of superalloy material 12. It should be understood that while composite particles 10a and 10b are shown, fewer or more composite particles can be used. Furthermore, while particles of superalloy material 12 are shown, it should be understood that a powder of superalloy material 12 does not need to be used in the construction of a component and that the component may be made of solely of composite particles 10a or 10a and 10b.

Using the different composite particles 10a and 10b, or through the use of different carbon nanostructures 14a, 14b, different compositions and concentrations of carbon nanostructures 14a, 14b may be obtained during the construction of a component. This can be used to employ concentrations at one particular area over another in order to obtain the best characteristics for a particular component. The local concentration of a particular carbon nanostructure 14a can vary over a large range and be adjusted according to the desired characteristics of the component. Different mechanical properties can be achieved by an appropriate mixture of different types of carbon nanostructures 14a, 14b, such as carbon nanotubes and carbon nanospheres, as well as concentration with respect to powders of superalloy material 12.

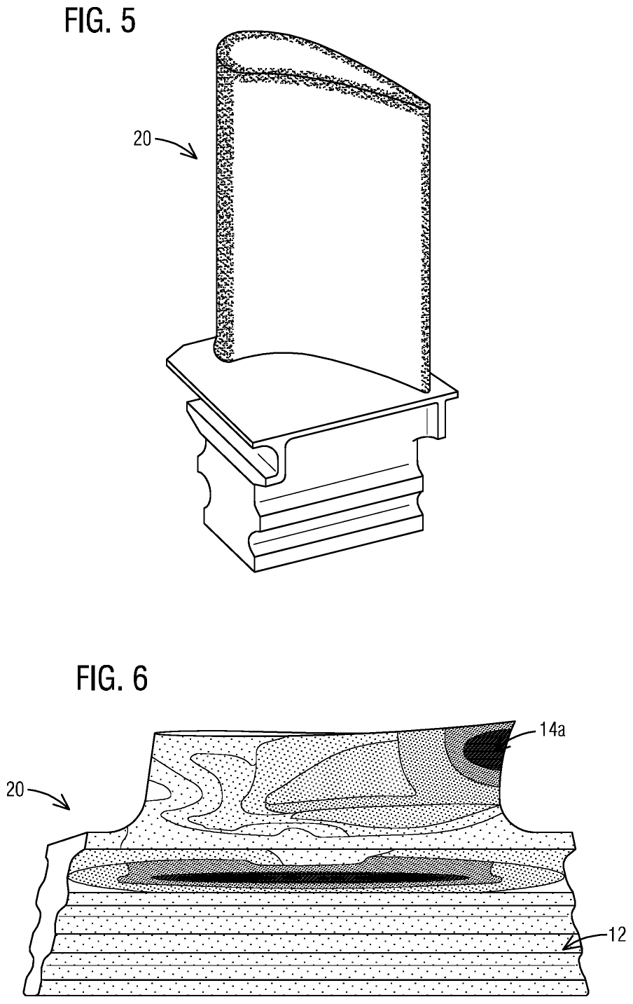

FIG. 4 shows an example of an additive manufacturing powder bed 18. In the powder bed 18 a blade 20 is being made. The blade 20 is being made via the use of a powder of superalloy material 12, a first powder formed of carbon nanostructures 14a and a second powder formed of carbon nanostructures 14b. The powder bed 18 may comprise the powders as disclosed or could contain composite particles 10a that have a specific concentration of the various carbon nanostructures. Further, a first laser beam 19a that melts the powder, as well as a second powder beam 19b with superalloy material 12 is shown. A multiplicity of laser beams, such as first laser beam 19a and second laser beam 19b with different particles containing different superalloy(s), types, concentrations, and sizes of carbon structures, can be introduced in order to achieve any desired concentration of types and sizes of carbon nanostructures 14a, 14b and superalloy material 12 at different locations in the manufactured component, see for example FIG. 5 and FIG. 6.

FIG. 5 shows an illustration of the finished blade 20. The top portion of the finished blade 20 may have a high concentration of carbon nanostructures 14 and carbon nanostructures 15. Additionally, the leading and trailing edge of the blade 20 may be made with different concentrations of carbon nanostructures 14 and carbon nanostructures 15. FIG. 6 shows the root of the blade 20 with the various shadings representing concentrations of carbon nanostructures 14 and carbon nanostructures 15. The various degrees of shading represent how the concentration levels can be controlled at a very fine level. This increases the ability create structure that is finely adapted to environmental impacts.

The needs of the blade 20 can be determined by performing a finite element analysis of the blade 20 in the anticipated service conditions and then relating stress and temperature field. Also life number contour plots for the various failure mechanisms can be applied to the concentrations of carbon nanostructures. This can be used to improve the entire component or to target specific regions of the component where there may be failure conditions.

While a blade 20 is disclosed above, other applications of the additive manufacturing process using carbon nanostructures may be used. For example burner nozzles, or other components in the gas turbine engine that are exposed to harsh environments may benefit from being additively manufactured using carbon nanostructures. For example the above described additive manufacturing process may also be used for combustion baskets, transitions, vanes, etc.

In addition to the local variation of carbon nanostructure material as described above, the metallic base material may be varied by using different concentrations of one or more alloys in the form of multiple powder beams with different superalloys in the same manner it is performed with the use of the carbon nanostructures. In this manner one can achieve various metallic concentration gradients. The metallic concentration gradients can be stabilized by the carbon nanostructures.

Also, by controlling the local temperature of a region being impacted by a laser, different structural phases of the alloy may be achieved. For example martensitic steels and austenitic steels may be formed. With these base alloy changes in terms of concentration and structural phases further modifications and achievement of the desired properties for the component can occur. For example, as shown in FIG. 5, the blade 20 may have a different Ni-base superalloy (or a steel) in the root as for the airfoil. Additionally the trailing and leading edges may have high carbon nanostructure concentrations.

By enhancing the thermo-mechanical properties, such as strength, fatigue resistance, etc., of Ni-based additive manufactured parts, i.e. blades/Vanes/transitions by adding carbon nanostructures to the additive manufacturing processes, the manufactured components can be utilized at higher temperatures and for longer times.

These enhanced properties can be utilized to increase turbine inlet temperature and thus increase efficiency of the gas turbine engine process. Furthermore, costs may be minimized by adding the improved structure only to areas where it will be utilized, such as the leading or trailing edge of blades or vanes.

As provided above, the trailing and leading edges may have high carbon nanostructure concentrations. In more detail, in some embodiments, the concentration of the carbon nanostructures (14a, 14b) at the leading edge or the trailing edge of the gas turbine component is at least two times (but may be at least five times and even ten times) the concentration of the carbon nanostructures (14a, 14b) at a middle of the gas turbine component. The middle of the gas turbine component being the centre of mass in some embodiments or the geometric centre in other embodiments. Additionally, in some embodiments, the carbon nanostructures (14a, 14b) are spaced such that the majority of carbon nanostructures (14a, 14b) are at a distance greater than the average size of the carbon nanostructures (14a, 14b), although the distance may be twice or even ten times the average size of the carbon nanostructures (14a, 14b).

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A gas turbine component made via additive manufacturing comprising:
superalloy material (12) and carbon nanostructures (14a, 14b), wherein the carbon nanostructures are interspersed throughout the gas turbine component via additive manufacturing.

2. The gas turbine component of claim 1, wherein the carbon nanostructures (14a, 14b) are interspersed throughout the gas turbine component at different concentration levels.

3. The gas turbine component of claim 1, wherein the carbon nanostructures (14a, 14b) are interspersed throughout the gas turbine component at different concentration levels and comprise more than one type of carbon nanostructure.

4. The gas turbine component of claim 3, wherein the carbon nanostructures (14a, 14b) are selected from a group consisting of one carbon nanostructure selected from the group consisting of single-or multi-walled carbon nanotubes, nanobuds, spherical fullerene, graphene, or carbon nano-yarn .

5. The gas turbine component of claim 1, wherein the superalloy material (12) and the carbon nanostructures (14a, 14b) form composite particles (10a, 10b) for use in the additive manufacturing process.

6. The gas turbine component of claim 2, wherein the carbon nanostructures (14a, 14b) are at a higher concentration at a leading edge or a trailing edge of the gas turbine component.

7. The gas turbine component of claim 6, wherein the concentration of the carbon nanostructures (14a, 14b) at the leading edge or the trailing edge of the gas turbine component is at least two times the concentration of the carbon nanostructures (14a, 14b) at a middle of the gas turbine component.

8. The gas turbine component of claim 7, wherein the concentration of the carbon nanostructures (14a, 14b) at the leading edge or the trailing edge of the gas turbine component is at least five times the concentration of the carbon nanostructures (14a, 14b) at a middle of the gas turbine component.

9. The gas turbine component of claim 2, wherein the carbon nanostructures (14a, 14b) are spaced such that the majority of carbon nanostructures (14a, 14b) are at a distance greater than the average size of the carbon nanostructures (14a, 14b).

10. The gas turbine component of claim 2, wherein the carbon nanostructures (14a, 14b) are spaced such that the majority of carbon nanostructures (14a, 14b) are at a distance greater than twice the average size of the carbon nanostructures (14a, 14b).

11. A method of making a component comprising:
using an additive manufacturing powder in an additive manufacturing apparatus in order to form the gas turbine component via additive manufacturing, wherein the additive manufacturing powder is a composition comprising superalloy material (12) and carbon nanostructures (14a, 14b).

12. The method of claim 11, wherein the carbon nanostructures (14a, 14b) are interspersed throughout the additive manufacturing powder at different concentration levels and comprise more than one type and/or size of carbon nanostructure selected from the group consisting of single-or multi-walled carbon nanotubes, nanobuds, spherical fullerene, graphene, or carbon nano-yarn.

13. The method of claim 11, wherein the additive manufacturing powder is formed from composite particles (10a, 10b) formed from carbon nanostructures (14a, 14b) and the superalloy material (12).

14. The method of claim 11, further comprising additively manufacturing different portions of the gas turbine component using the additive manufacturing powder with a first concentration of carbon nanostructure types and sizes, and a second additive manufacturing powder with a second concentration of carbon nanostructure types and sizes.

15. The method of claim 11, further comprising additively manufacturing different portions of the gas turbine component using the additive manufacturing powder with a first concentration of carbon nanostructures types and sizes with a powder bed and a multiplicity of additive manufacturing laser beams (19a, 19b).

16. The gas turbine component of claim 11, wherein the carbon nanostructures (14a, 14b) are at a higher concentration at a leading edge or a trailing edge of the gas turbine component.

17. The gas turbine component of claim 12, wherein the concentration of the carbon nanostructures (14a, 14b) at the leading edge or the trailing edge of the gas turbine component is at least two times the concentration of the carbon nanostructures (14a, 14b) at a middle of the gas turbine component.

18. The gas turbine component of claim 13, wherein the concentration of the carbon nanostructures (14a, 14b) at the leading edge or the trailing edge of the gas turbine component is at least five times the concentration of the carbon nanostructures (14a, 14b) at a middle of the gas turbine component.

19. The gas turbine component of claim 11, wherein the carbon nanostructures (14a, 14b) are spaced such that the majority of carbon nanostructures (14a, 14b) are at a distance greater than the average size of the carbon nanostructures (14a, 14b).

20. A method of making a composite particle comprising;
casting a slab comprising superalloy material (12) and at least one carbon nanostructure (14a); and
milling the slab to form the composite particle (10a) comprising the superalloy material (12) and the at least one carbon nanostructure (14a), wherein the composite particle (10a) is for an additive manufacturing process.
